(19) United States
(12) Patent Application Publication
(10) Pub. No.: US 2024/0419311 A1
(43) Pub. Date: Dec. 19, 2024

(54) METHOD, SYSTEM, DEVICE, AND MEDIUM FOR INFORMATION PROCESSING

(71) Applicant: Beijing Zitiao Network Technology Co., Ltd., Beijing (CN)

(72) Inventors: Yizhe Yang, Beijing (CN); Jiahe Ma, Beijing (CN); Quan Chen, Beijing (CN); Ang Zhang, Beijing (CN); Chong Niu, Beijing (CN); Zhenghua Hao, Beijing (CN); Yong Li, Beijing (CN); Eryou Hao, Beijing (CN); Penglin Li, Beijing (CN); Ye Yuan, Beijing (CN)

(21) Appl. No.: 18/819,694

(22) Filed: Aug. 29, 2024

(30) Foreign Application Priority Data
Aug. 30, 2023 (CN) 202311109603.0

(51) Int. Cl. G06F 3/0484

(52) U.S. Cl. CPC G06F 3/0484

(57) ABSTRACT

The present application provides a method and system, a device, and a medium. The method for information processing includes: obtaining an information processing state, wherein the information processing state is used for characterizing a processing state for target information, and the target information is generated according to input information on a dialogue page of a digital assistant; determining, according to the information processing state, display content matched with the information processing state; and displaying, on the dialogue page of the digital assistant, the display content matched with the information processing state. The method reduces the interaction complexity of users in a human-computer dialogue process and improve the operation experience of users.

### CROSS-REFERENCE TO RELATED APPLICATION(S)

This application claims priority to Chinese Application No. 202311109603.0, filed on Aug. 30, 2023, which is incorporated herein by reference in its entirety.

### FIELD

The present application relates to the field of computer technologies, and in particular, to a method and system, an electronic device, and a computer-readable storage medium for information processing.

### BACKGROUND

With the continuous development of computer technology, the application scope of a natural language processing technology gradually increases. When the natural language processing technology is applied to a human-computer dialogue scenario, a digital assistant such as chatting robot that has a dialogue with a user may be generated.

During the dialogue between the user and the aforementioned digital assistant, the user may interact with the digital assistant through a dialogue page loaded by a client. For example, the user can enter a question or view generated responses through the dialogue page. For another example, through the dialogue page, the user may instruct to stop generating responses and to regenerate responses.

The interaction in the above dialogue process is complex. There is an urgent need in the industry for a clear and concise information processing method to reduce the interaction complexity between users and digital assistants and then improve the operation experience of users.

### SUMMARY

The present application provides a method for information processing. The method is applied to a human-computer dialogue scenario. A processing process of a digital assistant for target information is divided into a plurality of different information processing states to display different content on a dialogue page, thereby reduce the interaction complexity of users in a human-computer dialogue process. The present application further provides a system corresponding to the above method, an electronic device, a computer-readable storage medium, and a computer program product.

In a first aspect, the present application provides a method for information processing. The method includes:
obtaining an information processing state, wherein the information processing state is used for characterizing a processing state for a target information, and the target information is generated according to input information in a dialogue page of a digital assistant;
determining, according to the information processing state, display content matched with the information processing state; and
displaying, in the dialogue page of the digital assistant, the display content matched with the information processing state.

In a second aspect, the present application provides a system for information processing. The system includes:
an obtaining module, configured to obtain an information processing state, wherein the information processing state is used for characterizing a processing state for target information, and the target information is generated according to input information on a dialogue page of a digital assistant;
a determining module, configured to determine, according to the information processing state, display content matched with the information processing state; and
a displaying module, configured to display, in the dialogue page of the digital assistant, the display content matched with the information processing state.

In a third aspect, the present application provides an electronic device. The electronic device includes a processor and a memory. The processor communicates with the memory. The processor is configured to execute instructions stored in the memory to cause the device to perform the page displaying method as described in the first aspect or any implementation of the first aspect.

In a fourth aspect, the present application provides a computer-readable storage medium, having instructions stored therein. The instructions instruct an electronic device to perform the page displaying method as described in the first aspect or any implementation of the first aspect.

In a fifth aspect, the present application provides a computer program product including instructions. When the computer program product is run on an electronic device, the electronic device is caused to perform the page displaying method as described in the first aspect or any implementation of the first aspect.

The present application can be further combined to provide more implementations based on the implementations provided in all the above aspects.

It can be seen from the above technical solutions that the present application has the following advantages:

The present application provides a method for information processing. The method includes: first obtaining an information processing state, wherein the information processing state is used for characterizing a processing state for target information, and the target information is generated according to input information on a dialogue page of a digital assistant; then determining, according to the information processing state, display content matched with the information processing state; and displaying, on the dialogue page of the digital assistant, the display content matched with the information processing state.

According to the method, for a human-computer dialogue scenario, an information processing process of a digital assistant is divided into a plurality of states, thus displaying display content corresponding to information processing states in a dialogue page, thereby reduce the interaction complexity of users in a human-computer dialogue process and enhancing the operation experience of users.

### BRIEF DESCRIPTION OF THE DRAWINGS

In order to describe the technical method of the embodiments of the present application more clearly, the following briefly describes the accompanying drawings required in the embodiments.

FIG. 1 is a flowchart of a human-computer dialogue according to an embodiment of the present application;

FIG. 2 is a flowchart of an method for information processing according to an embodiment of the present application;

FIG. 3A to FIG. 3C are schematic diagrams of a dialogue page according to an embodiment of the present application;

FIG. 4 is a schematic structural diagram of a system for information processing according to an embodiment of the present application; and

FIG. 5 is a schematic structural diagram of an electronic device according to an embodiment of the present application.

### DETAILED DESCRIPTION OF EMBODIMENTS

The terms “first” and “second” in the embodiments of the present application are used for descriptive purposes only and are not to be construed as indicating or implying relative importance or to implicitly indicate the number of technical features indicated. Thus, features defined as “first” and “second” explicitly or implicitly include one or more of the features.

Some technical terms in the embodiments of the present application are first introduced.

Natural language processing (NLP) is a machine learning technology to enable a computing device to read, process, and understand human languages. The computing device can complete multiple tasks based on the NLP, including but not limited to part-of-speech tagging, word sense disambiguation, voice recognition, machine translation, emotion analysis, and the like.

Applying the natural language processing technology to a human-computer dialogue scenario has generated a digital assistant such as chatting robot that has a dialogue with a user. Human-computer dialogue is a process of allowing a computing device (such as a digital assistant that supports human-computer dialogue) to understand and use natural languages to simulate dialogues or chats with people. The human-computer dialogue is usually implemented based on the natural language processing technology. A user enters an information to a server through a client, and the server analyzes and processes the input information through a pre-trained language model to generate a response information of the input information, and returns the response information to the user, thereby achieving the human-computer dialogue.

Considering that the response information generated by the server can be long, the server can transmit the response information to the client in a stream transmission manner. Stream transmission is a transmission mode in which the server transmits data to the client in real time in a manner of delivering a small amount of data once. In other words, the server can transmit the generated response information multiple times, achieving “generation while transmission”. For example, when the input information is “Please write a 2000 word essay entitled “Where is Spring?”, it takes time for the server to generate all response information. To avoid too long waiting time, the server can transmit the response information to the client in multiple times. Namely, after generating some of the response information, the server can transmit the generated response information to the client to cause the client to present the generated response information.

In the human-computer dialogue process, the user may conduct interaction through a dialogue page loaded by the client. For example, the user can enter an information or view the response information generated by the digital assistant through the dialogue page of the digital assistant. For another example, the user can instruct to stop generating response information and to regenerate response information through the dialogue page of the digital assistant.

The interaction process in the above human-computer dialogue process is complex. There is an urgent need in the industry for a clear and concise information processing method to reduce the interaction complexity between users and digital assistants and then improve the operation experience of users.

In view of this, the present application provides an information processing method. The method includes: first obtaining an information processing state, wherein the information processing state is used for characterizing a processing state for target information, and the target information is generated according to input information in a dialogue page of a digital assistant; then determining, according to the information processing state, display content matched with the information processing state; and displaying, in the dialogue page of the digital assistant, the display content matched with the information processing state.

According to the method, for a human-computer dialogue scenario, an information processing process of a digital assistant is divided into a plurality of states, thus displaying display content corresponding to information processing states on a dialogue page, thereby reduce the interaction complexity of users in a human-computer dialogue process and enhancing the operation experience of users.

To make the technical solutions of the present application clearer and more easily to understand, a human-computer dialogue process of the present application will be described below in conjunction with the accompanying drawings.

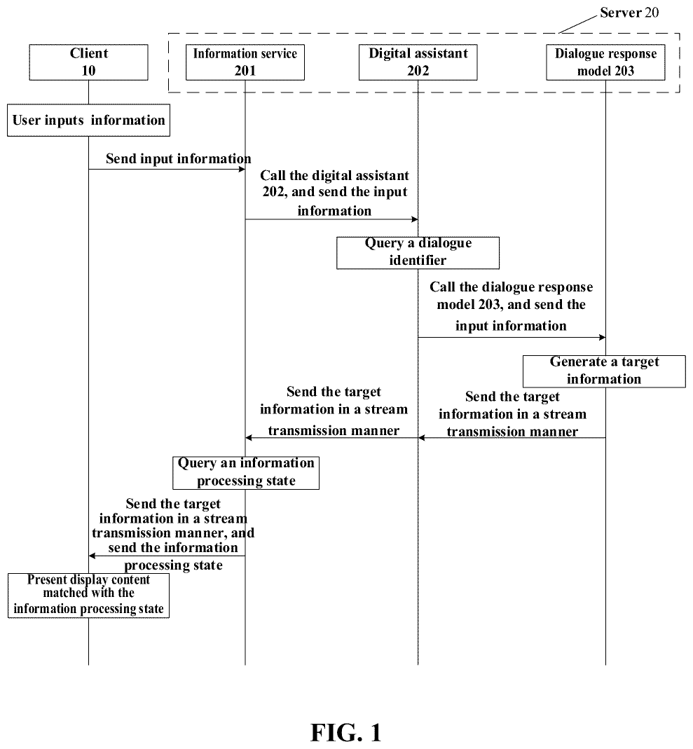

FIG. 1 shows a flowchart of a human-computer dialogue. The human-computer dialogue occurs between a client 10 and a server 20. In some embodiments, the server 20 may be an independent system capable of performing a human-computer dialogue with the client 10, such as an independent chatting robot. In some other embodiments, the server 20 may be integrated into other systems, such as a service platform, to provide a human-computer dialogue service as a system module of the service platform.

In this embodiment of the present application, integrating the server 20 into the service platform is taken as an example. The server 20 may include an information service 201, a digital assistant 202, and a dialogue response model 203. The information service 201 is used for managing information in the service platform, including but not limited to: information (also referred to as chatting information) between users, information (also referred to as system information) between users and a system module in the service platform, and the like. The digital assistant 202 is configured to provide a human-computer dialogue function. The digital assistant 202 can be an independent system module in the service platform or a service deployed in a system module of the service platform, such as a service deployed in a document module or a conference module. The dialogue response model 203 is configured to generate a corresponding response information for an input information of a user. For example, the dialogue response model 203 may include a deep learning model trained using a large amount of text data.

Specifically, the digital assistant 202 provides a dialogue page. The client 10 loads the dialogue page of the digital assistant 202, so that the user may interact with the server 20 through the dialogue page. For example, the user may enter an information through the dialogue page.

Next, the client 20 may transmit the input information to the server 10, so that the server 10 generates target information according to the input information and transmits the target information. In a specific implementation, the client 20 may send the input information to the information service 201. The information service 201 analyzes the input information and determines that it is an information for a human-computer dialogue. Thus, the digital assistant 202 is called, and the input information is sent to the digital assistant 202. The digital assistant 202 may query and obtain a dialogue identity (dialogue ID) according to the input information. The dialogue ID may be used for identifying a dialogue to which the input information belongs. In this way, the digital assistant 202 may send the input information, the dialogue ID, and an auth token to the dialogue response model 203, thereby calling the dialogue response model 203 to generate the target information. The auth token is used for authentication in the process of generating the target information. The dialogue response model 203 may authenticate, according to the auth token, the digital assistant 202 that currently asks for a dialogue response dialogue; after the authentication succeeds, determine, according to the dialogue ID, the dialogue to which the input information belongs; and generate the target information by using the input information and information context in the dialogue to which the input information belongs. The target information may include the response information generated by the dialogue response model 203.

Further, the dialogue response model 203 may send the target information to the digital assistant 202 in a stream transmission manner, and the digital assistant 202 sends the target information to the information service 201. The information service 201 queries an information processing state and sends the target information and the information processing state to the client 10. In this way, the client 10 may determine, according to the information processing state, display content matched with the information processing state, and display the display content matched with the information processing state on the dialogue page of the digital assistant 202, such as displaying an icon or a control that is matched with the information processing state, so that the above display content is used to assist the user in the interaction in the human-computer dialogue process.

For ease of understanding the technical solutions of the embodiments of the present application, the following will make an explanation in conjunction with the accompanying drawings.

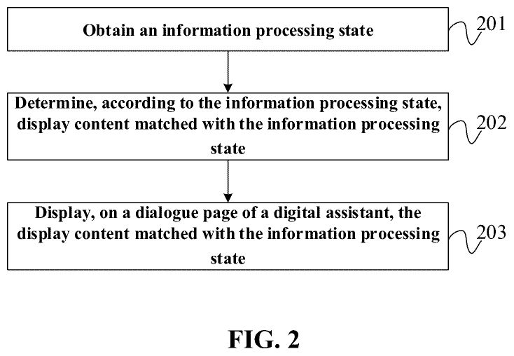

FIG. 2 is a flowchart of an information processing method according to an embodiment of the present application. The method specifically includes:

S201: Obtaining an information processing state.

The information processing state may be used for characterizing a processing state for a target information. The target information may be generated according to input information in a dialogue page of a digital assistant.

The dialogue page of the digital assistant is an interaction page provided by the digital assistant and used for a user to achieve a human-computer dialogue. In some possible implementations, the dialogue page of the digital assistant may be a graphics user interface (GUI) or a command user interface (CUI).

The dialogue page of the digital assistant may include an information input region. A user may trigger an input request in the information input region. Specifically, the user can trigger the input request by clicking on the information input region and enter an information in the information input region. In some embodiments, the input information may be different types of information such as text, images, and files entered by the user. In some other embodiments, the user may alternatively enter an information by triggering a control. For example, when the user triggers control “summary text”, the input information can be used for indicating a text summary. In addition, when a device used by the user supports voice inputting, the user can further enter an information by inputting a voice.

In a specific implementation, in response to the input request triggered by the user on the dialogue page of the digital assistant, the input information may be obtained, and the target information may be generated according to the input information. In this way, the target information includes a response information for the input information.

In other words, the information processing method of this embodiment of the present application may be applied to a human-computer dialogue scenario. When a user triggers an input request on a dialogue page, a response information may be determined using a dialogue response model according to the information inputted by the user.

After the target information is generated, considering that the target information usually includes a large amount of information data, the target information may be transmitted in a stream transmission manner. For example, the target information may be transmitted in multiple times at a fixed time interval. Namely, newly generated information data may be transmitted at the fixed time interval. For another example, the target information may be transmitted in multiple times according to a fixed amount of information data. Namely, after a certain amount of information data is generated, the newly generated information data is transmitted.

In some possible implementations, the stream transmission may be achieved in a manner of transmitting information data in each transmission of the target information. In a specific implementation, the transmitted information data may include an identifier used for indicating a sequence number of transmission of the information data. For example, the information data may include a sequenceID field. This field may represent a sequence number of transmission of current information data in the target information.

Further, the transmitted information data may include at least one of incremental data and full data. The incremental data means a difference between the generated target information during the current information transmission and the generated target information during the last information transmission, and the full data means all the generated target information during the current information transmission. For example, if the target information is “123456”, during the first transmission, the generated target information is “123”, and during the second transmission, the generated target information is “123456”. For the second transmission, the incremental data is “456”, and the full data is “123456”.

FIG. 1 is taken as an example. In some possible implementations, the information data sent by the dialogue response model 203 to the digital assistant 202 may include incremental data and full data. The information data sent by the digital assistant 202 to the information service 201 may include both the incremental data and the full data. The information data sent by the information service 201 to the client 10 may only include the incremental data. In this way, the client 10 may achieve the stream transmission of the target information based on the incremental data. Meanwhile, the full data may be saved in the information service 201. The full data stored in the information service 201 may be called during the transmission of the target information to avoid a transmission error.

The above explains the generation and transmission processes of the target information, and the following will explain the process of obtaining the information processing state. In some possible implementations, the information processing state may be determined through an information processing identifier. In a specific implementation, an information processing identifier can be obtained, and the information processing state can be determined according to a mapping relationship between the information processing identifier and the information processing state.

In this embodiment of the present application, a processing process (which may include, for example, a generation process of the target information and a transmission process of the target information) for the target information during a human-computer dialogue is divided into a plurality of different processing states which are represented by different information processing identifiers, so that an information processing state can be determined according to an information processing identifiers. In this way, in the processing process for the target information, a processing state is represented by a fine-grained information processing identifier. During the displaying on the dialogue page, display content is determined according to the information processing state.

FIG. 1 is taken as an example. In some possible implementations, the information processing identifier can be triggered to be modified by the dialogue response model 203. Specifically, the dialogue response model 203 can send the information processing identifier to the digital assistant 202 according to the generation process of the target information and the transmission process of the target information. The digital assistant 202 sends the information processing identifier to the information service 201. In this way, the information service 201 can store or update the information processing state according to the mapping relationship between the information processing identifier and the information processing state.

In a specific implementation, the information processing state may be stored in a specific data structure. In some possible implementations, the information processing state can be stored as the following RoundInfo data structure:
information RoundInfo {
   enum Status {
      UNKNOWN=0; I/to be transmitted
      RESPONDING=1; I/transmission not completed
      UNKNOWN=2; I/transmission completed
      INTERRUPT=3; I/interrupt
      ROUND_ERROR=4; I/transmission error
   }
   optional int64 chat_id=1; //group id
   optional int64 chat_mode_id=2;
   optional int64 round_id=3; //round id
   optional Status=4; //state
   optional int64 update_time=5; //update time
   optional int32 round_id_position=6; //round_id position
   optional int32 round_last_position=7; //use according to information update state in rounds
   }

In the RoundInfo data structure, 0, 1, 2, 3, and 4 are used to represent information processing states, so that the consistency of the information processing states is maintained in a concurrent scenario to avoid an information transmission error.

A specific information processing state will be explained below in conjunction with FIG. 1.

In some embodiments, the client 10 sends the input information to the server 20. The dialogue response model 203 receives the input information, but has not yet started to transmit the target information. For example, the dialogue response model 203 has not yet generated the target information, or the dialogue response model 203 has already generated the target information and gets ready to start first information transmission. At this point, in response to a successful reception response made to the input information, a first information processing identifier is obtained; or, in response to a transmission request for the target information, a second information processing identifier is obtained, and the information processing state is determined as a first state according to a mapping relationship between the first information processing identifier and the information processing state, or a mapping relationship between the second information processing identifier and the information processing state. The first state indicates that the target information is to be transmitted.

In some other embodiments, after the target information is generated, the server 20 streams the target information to the client 10 in the stream transmission manner. At this point, in response to transmitting the target information, a third information processing identifier is obtained, and the information processing state is determined as a second state according to a mapping relationship between the third information processing identifier and the information processing state. The second state indicates that the transmission of the target information is not completed.

In some other embodiments, the server 20 transmits the target information to the client 10 to complete the information transmission process. At this point, in response to the target information including an end identifier, a fifth information processing identifier is obtained, wherein the end identifier in the target information indicates that the transmission of the target information is completed. For example, the end identifier indicates that currently transmitted information data is the last piece of information data in the target information. Next, the information processing state is determined as a third state according to a mapping relationship between the fifth information processing identifier and the information processing state. The third state indicates that the transmission of the target information is completed.

Based on the above description, it can be determined that in this embodiment of the present application, the processing process of the target information may be divided into the first state indicating that the target information is to be transmitted, the second state indicating that the transmission of the target information is not completed, and the third state indicating that the transmission of the target information transmission is completed. The information processing states can be represented by different information processing identifiers. Referring to Table 1, when the server 20 receives the input information and has not yet generated the target information, the first information processing identifier can be 10001; when the server 20 generates the target information and gets ready to start to transmit the target information, the second information processing identifier can be 10011; when the server 20 transmits the target information, the third information processing identifier can be 11000; and when the server 20 completes the transmission of the information, the fifth information processing identifier can be 10000. In this way, the information processing state can be determined according to the information processing identifier.

TABLE 1

| | | | Content of | Content |
|---|---|---|---|---|
| | | State | incremental | of full |
| sequenceID | State | code | information | information |
| 0 | Preparing | 10001 | — | — |
| 1 | About to start to | 10011 | — | — |
| | transmit the target | | | |
| | information | | | |
| 2 | Transmission is not | 11000 | He | He |
| | completed | | | |
| 3 | Transmission is not | 11000 | llo | Hello |
| | completed | | | |
| 4 | Transmission of the | 10000 | — | Hello |
| | target information is | | | |
| | completed | | | |

This embodiment of the present application further supports generating a plurality of response information for the input information. In some possible implementations, the target information may include a first information and a second information, and the server 20 may transmit the first information before transmitting the second information. At this point, in response to the first information including an end identifier and a transmission request for the second information, a fourth information processing identifier is obtained, wherein the end identifier indicates that transmission of the first information is completed. For example, the end identifier indicates that currently transmitted information data is the last piece of information data in the first information. Next, the information processing state is determined as a second state according to a mapping relationship between the fourth information processing identifier and the information processing state. The second state indicates that the transmission of the target information is not completed.

In some embodiments, the first information and the second information may be different types of information. For example, the first information can be a text information, and the second information can be a card information. The text information means an information composed of text, and the card information means an information composed of various types of content, such as text, median information, and an interaction component.

Referring to Table 2, when the server 20 receives the input information and has not yet generated the target information, the first information processing identifier can be 10001; when the server 20 generates the target information and gets ready to start to transmit the target information, the second information processing identifier can be 10011; when the server 20 transmits the first information, the third information processing identifier can be 11000; when the server 20 completes the transmission of the first information and gets ready to start to transmit the second information, the fourth information processing identifier can be 10100; and when the server 20 completes the transmission of the target information (i.e. the first information and the second information), the fifth information processing identifier can be 10000.

TABLE 2

| | | | Content of | Content |
|---|---|---|---|---|
| | | State | incremental | of full |
| sequenceID | State | code | information | information |
| 0 | Preparing | 10001 | — | — |
| 1 | About to start to | 10011 | — | — |
| | transmit the first | | | |
| | information | | | |
| 2 | Transmission of the | 11000 | He | He |
| | first information | | | |
| | is not completed | | | |
| 3 | Transmission of the | 11000 | llo | Hello |
| | first information is | | | |
| | not completed | | | |
| 4 | Transmission of the | 10100 | — | — |
| | first information is | | | |
| | completed | | | |
| 5 | Transmission of the | 10100 | {Card | {Card |
| | second information | | content} | content} |
| | is completed | | | |
| 6 | Transmission of the | 10000 | — | — |
| | target information is | | | |
| | completed | | | |

In a case that the target information includes a plurality of information, this embodiment of the present application achieves the continuous transmission of the target information by adding the fourth information processing identifier. In this way, one round of dialogue of the human-computer dialogue is no longer limited to “one question and one answer”, but may reply a plurality of response information based on the input information of the user. Moreover, the generated target information can be of different types of information. This enriches the applicable scenarios of the human-computer dialogue.

Further, this embodiment of the present application further supports that the user interrupts the dialogue. For example, the user may interrupt the dialogue during the information transmission, thereby interrupting the generation and transmission of the target information, specifically, the user may interrupt the dialogue by triggering an interrupt control on the dialogue page of the digital assistant. At this point, in response to an interrupt request, a sixth information processing identifier can be obtained, and the information processing state may be determined as a fourth state according to a mapping relationship between the sixth information processing identifier and the information processing state. The fourth state indicates that the transmission of the target information is interrupted.

Referring to Table 3, when the server 20 receives the input information and has not yet generated the target information, the first information processing identifier may be 10001; when the server 20 generates the target information and gets ready to start to transmit the target information, the second information processing identifier can be 10011; when the server 20 transmits the target information, the third information processing identifier may be 11000; and after the user triggers the interrupt request, the sixth information processing identifier of the server 20 may be 10010. In this way, the information processing state is determined as the fourth state according to the mapping relationship between the sixth information processing identifier and the information processing state, thus achieving the interruption in the human-computer dialogue process.

TABLE 3

| | | | Content of | Content |
|---|---|---|---|---|
| | | State | incremental | of full |
| sequenceID | State | code | information | information |
| 0 | Preparing | 10001 | — | — |
| 1 | About to start to | 10011 | — | — |
| | transmit the target | | | |
| | information | | | |
| 2 | Transmission is not | 11000 | He | He |
| | completed | | | |
| 3 | Transmission is | 10010 | — | He |
| | interrupted | | | |

Further, this embodiment of the present application further supports content detection performed on human-computer dialogue content. In a specific implementation, content detection may be performed on the target information by calling a content detection system, thus avoiding that the target information may include risk content. The content detection system can be a system deployed in the server 20 or an independent system. When the content detection system detects that the target information includes risk content, a seventh information processing identifier (such as 13031) can be obtained. The information processing state is determined as the fifth state according to a mapping relationship between the seventh information processing identifier and the information processing state. The fifth state indicates that the target information includes the risk content.

S202: Determining display content matched with the information processing state according to the information processing state.

After the information processing state is obtained, the matched display content may be obtained according to the information processing state. A specific explanation will be made below.

In some embodiments, the information processing state is a first state. Namely, the information processing state indicates that the target information is to be transmitted. At this point, the display content matched with the information processing state can include a first icon. The first icon is used for characterizing that the input information has been received.

In some other embodiments, the information processing state is a second state. Namely, the information processing state indicates that the transmission of the target information is not completed. At this point, the display content matched with the information processing state may include a first control. The first control is used for interrupting the transmission of the target information.

In some other embodiments, the information processing state is a third state. Namely, the information processing state indicates that the transmission of the target information is completed. At this point, the display content matched with the information processing state can include a second control and/or a third control. The second control is used for updating the input information, and the third control is used for regenerating the target information.

S203: The display content matched with the information processing state is presented on the dialogue page of the digital assistant.

In this embodiment of the present application, different information processing states correspond to different pieces of display content. When the display content matched with the information processing state is 9 to the user, the user can intuitively and clearly understand the processing process for the target information through the display content, thus improving the use experience of the human-computer dialogue.

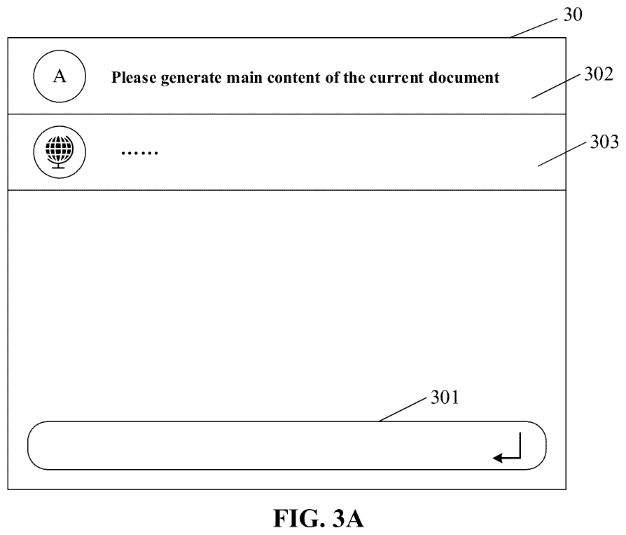

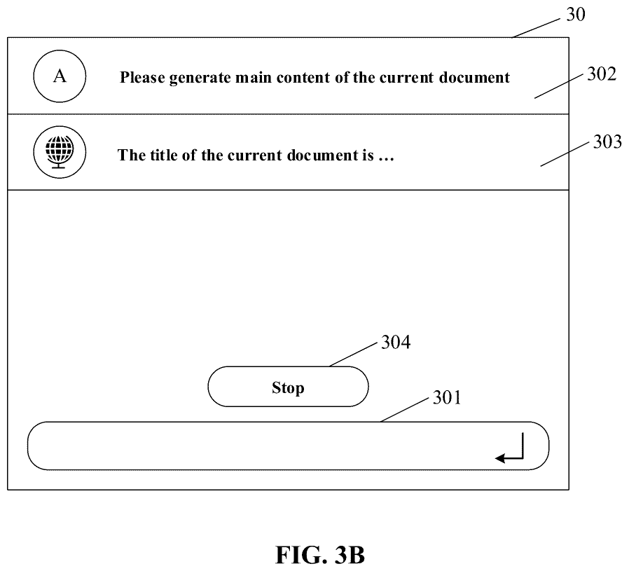

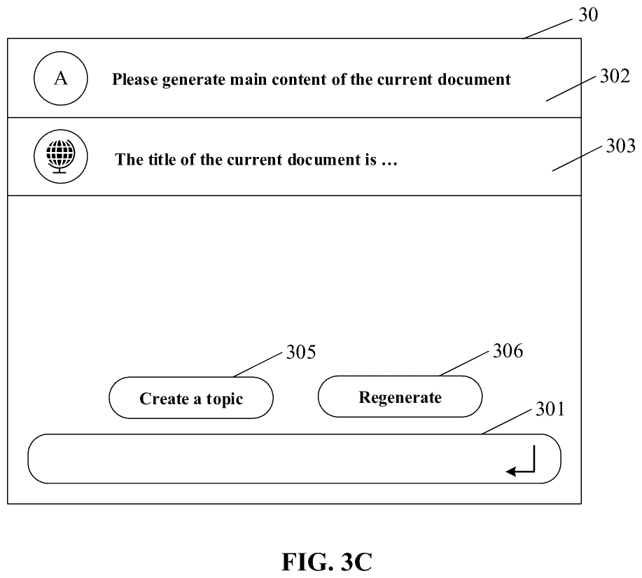

The following will make an explanation in conjunction with the accompanying drawings. In some embodiments, the information processing state is a first state. Referring to FIG. 3A, it shows a schematic diagram of a dialogue page. The dialogue page 30 includes an information input region 301, an input information displaying region 302, and a target information displaying region 303. Specifically, the information input region 301 is used for triggering the input request and obtaining the input information. The input information displaying region 302 is used for displaying the input information of the user. The target information displaying region 303 is used for displaying the target information generated according to the input information. FIG. 3A only shows one round of dialogue in a human-computer dialogue. After this round of dialogue ends, in response to a re-input request of the user, an input information reentered by the user can be presented on the dialogue page 30. For example, the input information reentered by the user is presented below the target information displaying region 303. As shown in FIG. 3A, in some possible implementations, the first icon may be “ . . . ”. By presenting the first icon in the target information displaying region 303, it can inform the user that the server 20 has received the input information and is getting ready to transmit the target information. This avoids that the user repeatedly sends the input information due to long-time waiting.

In some embodiments, the information processing state is a second state. Referring to FIG. 3B, it shows a schematic diagram of a dialogue page. The dialogue page 30 includes an information input region 301, an input information displaying region 302, a target information displaying region 303, and a first control 304. The first control 304 may be located above the information input region 301. In this way, when the transmission of the target information is not completed, namely, in a dialogue responding process, the user can interrupt the transmission of the target information by triggering the first control 304, so that the human-computer dialogue can be simply interrupted.

In some other embodiments, the information processing state is a third state. Referring to FIG. 3C, it shows a schematic diagram of a dialogue page. The dialogue page 30 includes an information input region 301, an input information displaying region 302, a target information displaying region 303, a second control 305, and a third control 306. The second control 305 and the third control 306 can be located above the information input region 301. In this way, after the transmission of the target information is completed, the user may update the input information belonging to a topic that is different from the current human-computer dialogue process by triggering the second control 305 to create a new human-computer dialogue topic, or the user may regenerate a target information for the current input information by triggering the third control 305, achieving the advancement of the human-computer dialogue process.

Further, when the information processing state is a fifth state, namely, when the information processing state indicates that the target information includes risk content, the target information displaying region of the dialogue page may not present the target information. For example, a mask symbol is presented in the target information displaying region to avoid the leakage of the risk content.

Based on the above content description, this embodiment of the present application provides an information processing method. The method includes: first obtaining an information processing state, wherein the information processing state is used for characterizing a processing state for target information, and the target information is generated according to input information on a dialogue page of a digital assistant; then determining, according to the information processing state, display content matched with the information processing state; and displaying, in the dialogue page of the digital assistant, the display content matched with the information processing state.

According to the method, for a human-computer dialogue scenario, an information processing process of a digital assistant is divided into a plurality of states, thus displaying display content corresponding to information processing states in a dialogue page, thereby reduce the interaction complexity of users in a human-computer dialogue process and enhancing the operation experience of users.

The information processing method provided by the embodiments of the present application has been described in detail above in conjunction with FIG. 1 to FIG. 3. The following will describe a system and a device provided by the embodiments of the present application in conjunction with the accompanying drawings.

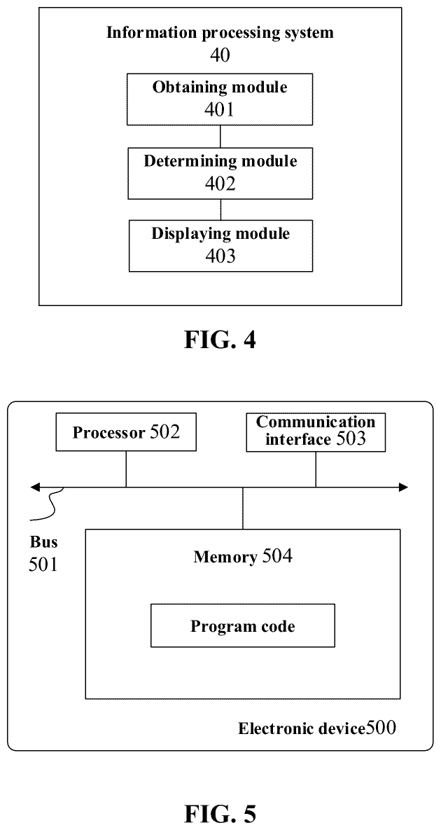

FIG. 4 is a schematic structural diagram of an information processing system. The system 40 includes:
an obtaining module 401, configured to obtain an information processing state, wherein the information processing state is used for characterizing a processing state for target information, and the target information is generated according to input information on a dialogue page of a digital assistant;
a determining module 402, configured to determine, according to the information processing state, display content matched with the information processing state; and
a displaying module 403, configured to display, on the dialogue page of the digital assistant, the display content matched with the information processing state.

In some possible implementations, the target information is generated by:
in response to an input request triggered by a user on the dialogue page of the digital assistant, obtaining input information; and
generating the target information according to the input information, wherein the target information includes a response information for the input information.

In some possible implementations, the information processing state is determined by:
obtaining an information processing identifier; and
determining the information processing state according to a mapping relationship between the information processing identifier and the information processing state.

In some possible implementations, the obtaining module 401 is specifically configured to:
in response to a successful reception response made to the input information, obtain a first information processing identifier; or,
in response to a transmission request for the target information, obtain a second information processing identifier; and
determine the information processing state as a first state according to a mapping relationship between the first information processing identifier and the information processing state, or a mapping relationship between the second information processing identifier and the information processing state, wherein the first state indicates that the target information is to be transmitted.

In some possible implementations, the obtaining module 401 is specifically configured to:
in response to transmitting the target information, obtain a third information processing identifier; and
determine the information processing state as a second state according to a mapping relationship between the third information processing identifier and the information processing state, wherein the second state indicates that the transmission of the target information is not completed.

In some possible implementations, the target information includes a first information and a second information. The obtaining module 401 is specifically configured to:
in response to the first information transmitted by the server including an end identifier and a transmission request of the server for the second information, obtain a fourth information processing identifier, wherein the end identifier indicates that transmission of the first information is completed; and
determine the information processing state as a second state according to a mapping relationship between the fourth information processing identifier and the information processing state, wherein the second state indicates that the transmission of the target information is not completed.

In some possible implementations, the obtaining module 401 is specifically configured to:
in response to the target information transmitted by the server including an end identifier, obtain a fifth information processing identifier, wherein the end identifier indicates that the transmission of the target information is completed; and
determine the information processing state as a third state according to a mapping relationship between the fifth information processing identifier and the information processing state, wherein the third state indicates that the transmission of the target information is completed.

In some possible implementations, the determining module 402 is specifically configured to:
determine, according to the information processing state being a first state, that the display content includes a first icon, wherein the first icon characterizes that the input information has been received.

In some possible implementations, the determining module 402 is specifically configured to:
determine, according to the information processing state being a second state, that the display content includes a first control, wherein the first control is used for interrupting the transmission of the target information.

In some possible implementations, the determining module 402 is specifically configured to:
determine, according to the information processing state being a third state, that the display content includes a second control and/or a third control, wherein the second control is used for updating the input information, and the third control is used for regenerating the target information.

The information processing system 40 according to the embodiments of the present application may correspond to the execution of the method according to the embodiments of the present application, and the above and other operations and/or functions of the various modules/units of the information processing system 40 are respectively designed to implement the corresponding processes of the various methods in the embodiment shown in FIG. 2. For simplicity, they will not be elaborated here.

The embodiments of the present application further provide an electronic device. The electronic device is specifically configured to achieve the functions of the information processing system 40 in the embodiment shown in FIG. 4.

FIG. 5 shows a schematic structural diagram of an electronic device 500. As shown in FIG. 5, the electronic device 500 includes a bus 501, a processor 502, a communication interface 503, and a memory 504. The processor 502, the memory 504, and the communication interface 503 communicate with each other through the bus 501.

The bus 501 can be a peripheral component interconnect (PCI) bus, an extended industry standard architecture (EISA) bus, or the like. The bus may be divided into an address bus, a data bus, a control bus, and the like. For ease of representation, only one thick line is used in FIG. 5, but it does not mean that there is only one bus or one type of bus.

The processor 502 can be one or more of a central processing unit (CPU), a graphics processing unit (GPU), a micro processor (MP), or a digital signal processor (DSP).

The communication interface 503 is used for external communication. For example, the communication interface 503 can be used for communicating with a terminal.

The memory 504 may include a volatile memory, such as a random access memory (RAM). The memory 504 may further include a non-volatile memory, such as a read-only memory (ROM), a flash memory, a hard disk drive (HDD), or a solid state drive (SSD).

The memory 504 has executable codes stored thereon, and the processor 502 executes the executable codes to perform the aforementioned information processing method.

Specifically, in a case of implementing the embodiment shown in FIG. 4, and in a case that the various modules or units of the information processing system 40 described in the embodiment of FIG. 4 are implemented through software, the software or program codes required to execute the functions of the various modules/units in FIG. 4 may be partially or entirely stored in the memory 504. The processor 502 runs the program codes corresponding to the various units stored in the memory 504 and performs the aforementioned information processing method.

The embodiments of the present application further provide a computer-readable storage medium. The computer-readable storage medium may be any usable medium that can be stored by a computing device, or a data storage device such as a data center including one or more usable media. The usable medium may be a magnetic medium (for example, a floppy disk, a hard disk drive, or a magnetic tape), an optical medium (for example, a DVD), a semiconductor medium (for example, a Solid State Disk), or the like. The computer-readable storage medium includes instructions. The instructions instruct the computing device to perform the above information processing method applied to the information processing system 40.

The embodiments of the present application further provide a computer program product. The computer program product includes one or more computer instructions. When the computer instructions are loaded and executed on a computing device, the processes or functions according to the embodiments of the present application are all or partially generated.

The computer instructions may be stored in a computer-readable storage medium or may be transmitted from one computer-readable storage medium to another computer-readable storage medium. For example, the computer instructions may be transmitted from a website, a computer, or a data center to another website, computer, or data center in a wired manner (for example, by using a coaxial cable, an optical fiber, or a digital subscriber line (DSL)) or a wireless (for example, infrared, radio, or microwave) manner.

When the computer program product is run by a computer, the computer performs any of the aforementioned information processing methods. The computer program product can be a software installation package. In a case that any of the foregoing information processing methods needs to be used, the computer program product can be downloaded and is run on the computer.

The flowcharts and block diagrams in the accompanying drawings illustrate possible system architectures, functions, and operations that may be implemented by a system, a method, and a computer program product according to the various embodiments of the present application. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units/modules described in the embodiments of the present application can be implemented through software or hardware. The names of the units/modules do not constitute a limitation on the units in a situation.

The functions described herein above may be performed, at least in part, by one or a plurality of hardware logic components. For example, nonrestrictively, example hardware logic components that can be used include: A Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of this embodiment of the present application, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

It should be noted that the various embodiments in this specification are described in a progressive manner, and each embodiment focuses on differences from other embodiments. The same and similar parts between all the embodiments can be referred to each other. Since the system or apparatus disclosed in the embodiments correspond to the method disclosed in the embodiments, the apparatus is described simply, and related parts are found in some of the explanations of the method.

It should be understood that in the present application, “at least one” means one or more, and “plurality” means two or more. The term “and/or” is used for describing an association relationship of related objects, indicating that there are three types of relationships. For example, “A and/or B” can represent: only A exists, only B exists, and A and B exist simultaneously, where A and B can be singular or plural. The character “/” usually indicates an “or” relation between associated objects. The term “at least one of the following items” or its similar expression means any combination of these items, including any combination of a single item or a plurality of items. For example, at least one of a, b, or c can represent: a, b, c, “a and b”, “a and c”, “b and c”, or “a and b and c”, where a, b, and c can be singular or plural.

It should be further noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device. Without further limitation, an element defined by the phrase “including a/an . . . ” does not exclude the presence of another identical element in the process, method, article or device that includes the element.

The steps of the method or algorithm described in conjunction with the embodiments disclosed herein can be implemented directly using hardware, software modules executed by the processor, or a combination thereof. The software modules can be placed in a RAM, an internal memory, a ROM, an EPROM, EEPROM, a register, a hard disk drive, a removable disk, a CD-ROM, or a storage medium in any other form known in the technical field.

The above explanations of the disclosed embodiments enable those skilled in the art to implement or use the present application. The various modifications to these embodiments will be apparent to those skilled in the art, and the general principles defined herein can be implemented in other embodiments without departing from the spirit or scope of the present application. Thus, the present invention is not limited to these embodiments shown herein, but accords with the broadest scope consistent with the principles and novel features disclosed herein.

I/We claim:

1. An information processing method, comprising:
obtaining an information processing state, wherein the information processing state is used for characterizing a processing state for a target information, and the target information is generated according to input information in a dialogue page of a digital assistant;
determining, according to the information processing state, display content matched with the information processing state; and
displaying, in the dialogue page of the digital assistant, the display content matched with the information processing state.

2. The method of claim 1, wherein the target information is generated by:
in response to an input request triggered by a user on the dialogue page of the digital assistant, obtaining the input information; and
generating the target information according to the input information, wherein the target information comprises a response information for the input information.

3. The method of claim 1, wherein the information processing state is determined by:
obtaining an information processing identifier; and
determining the information processing state according to a mapping relationship between the information processing identifier and the information processing state.

4. The method of claim 3, wherein obtaining an information processing identifier comprises:
in response to a successful reception response for the input information, obtaining a first information processing identifier; or,
in response to a transmission request for the target information, obtaining a second information processing identifier; and
wherein determining the information processing state according to a mapping relationship between the information processing identifier and the information processing state comprises:
determining the information processing state as a first state according to a mapping relationship between the first information processing identifier and the information processing state, or a mapping relationship between the second information processing identifier and the information processing state, wherein the first state indicates that the target information is to be transmitted.

5. The method of claim 3, wherein obtaining an information processing identifier comprises:
in response to transmitting the target information, obtaining a third information processing identifier; and
wherein determining the information processing state according to a mapping relationship between the information processing identifier and the information processing state comprises:
determining the information processing state as a second state according to a mapping relationship between the third information processing identifier and the information processing state, wherein the second state indicates that a transmission of the target information is not completed.

6. The method of claim 2, wherein the target information comprises first information and second information; and obtaining an information processing identifier comprises:
in response to the first information comprising an end identifier and a transmission request for the second information, obtaining a fourth information processing identifier, wherein the end identifier indicates that a transmission of the first information is completed; and
wherein determining the information processing state according to a mapping relationship between the information processing identifier and the information processing state comprises:
determining the information processing state as a second state according to a mapping relationship between the fourth information processing identifier and the information processing state, wherein the second state indicates that a transmission of the target information is not completed.

7. The method of claim 2, wherein obtaining an information processing identifier comprises:
in response to the target information comprising an end identifier, obtaining a fifth information processing identifier, wherein the end identifier indicates that a transmission of the target information is completed; and
wherein determining the information processing state according to a mapping relationship between the information processing identifier and the information processing state comprises:
determining the information processing state as a third state according to a mapping relationship between the fifth information processing identifier and the information processing state, wherein the third state indicates that a transmission of the target information is completed.

8. The method of claim 1, wherein determining, according to the information processing state, display content matched with the information processing state comprises:
determining, according to the information processing state being a first state, that the display content comprises a first icon, wherein the first icon characterizes that the input information has been received.

9. The method of claim 1, wherein determining, according to the information processing state, display content matched with the information processing state comprises:
determining, according to the information processing state being a second state, that the display content comprises a first control, wherein the first control is used for interrupting a transmission of the target information.

10. The method of claim 1, wherein determining, according to the information processing state, display content matched with the information processing state comprises:
determining, according to the information processing state being a third state, that the display content comprises a second control and/or a third control, wherein the second control is used for updating the input information, and the third control is used for regenerating the target information.

11. An electronic device, wherein the electronic device comprises a processor and a memory,
wherein the processor is configured to execute instructions stored in the memory to cause the electronic device to:
obtain an information processing state, wherein the information processing state is used for characterizing a processing state for a target information, and the target information is generated according to input information in a dialogue page of a digital assistant;
determine, according to the information processing state, display content matched with the information processing state; and
display, in the dialogue page of the digital assistant, the display content matched with the information processing state.

12. The electronic device of claim 11, wherein the electronic device is further caused to generate target information by:
in response to an input request triggered by a user on the dialogue page of the digital assistant, obtaining the input information; and
generating the target information according to the input information, wherein the target information comprises a response information for the input information.

13. The electronic device of claim 11, wherein the electronic device is further caused to determine the information processing state by:
obtaining an information processing identifier; and
determining the information processing state according to a mapping relationship between the information processing identifier and the information processing state.

14. The electronic device of claim 13, wherein the electronic device is further caused to obtain an information processing identifier by:
in response to a successful reception response for the input information, obtaining a first information processing identifier; or,
in response to a transmission request for the target information, obtaining a second information processing identifier; and
wherein determining the information processing state according to a mapping relationship between the information processing identifier and the information processing state comprises:
determining the information processing state as a first state according to a mapping relationship between the first information processing identifier and the information processing state, or a mapping relationship between the second information processing identifier and the information processing state, wherein the first state indicates that the target information is to be transmitted.

15. The electronic device of claim 14, wherein the electronic device is further caused to obtain an information processing identifier comprises:
in response to transmitting the target information, obtaining a third information processing identifier; and
wherein determining the information processing state according to a mapping relationship between the information processing identifier and the information processing state comprises:
determining the information processing state as a second state according to a mapping relationship between the third information processing identifier and the information processing state, wherein the second state indicates that a transmission of the target information is not completed.

16. The electronic device of claim 12, wherein the target information comprises first information and second information; and obtaining an information processing identifier comprises:
in response to the first information comprising an end identifier and a transmission request for the second information, obtaining a fourth information processing identifier, wherein the end identifier indicates that a transmission of the first information is completed; and
wherein determining the information processing state according to a mapping relationship between the information processing identifier and the information processing state comprises:
determining the information processing state as a second state according to a mapping relationship between the fourth information processing identifier and the information processing state, wherein the second state indicates that a transmission of the target information is not completed.

17. The electronic device of claim 12, wherein the electronic device is further caused to obtain an information processing identifier by:
in response to the target information comprising an end identifier, obtaining a fifth information processing identifier, wherein the end identifier indicates that a transmission of the target information is completed; and
wherein determining the information processing state according to a mapping relationship between the information processing identifier and the information processing state comprises:
determining the information processing state as a third state according to a mapping relationship between the fifth information processing identifier and the information processing state, wherein the third state indicates that a transmission of the target information is completed.

18. The electronic device of claim 11, wherein the electronic device is further caused to determine, according to the information processing state, display content matched with the information processing state by:
determining, according to the information processing state being a first state, that the display content comprises a first icon, wherein the first icon characterizes that the input information has been received.

19. A non-transitory computer-readable storage medium comprising instructions, wherein the instructions cause an electronic device to:
obtain an information processing state, wherein the information processing state is used for characterizing a processing state for a target information, and the target information is generated according to input information in a dialogue page of a digital assistant;
determine, according to the information processing state, display content matched with the information processing state; and
display, in the dialogue page of the digital assistant, the display content matched with the information processing state.

20. The non-transitory computer-readable storage medium of claim 19, wherein the target information is generated by:
in response to an input request triggered by a user on the dialogue page of the digital assistant, obtaining the input information; and
generating the target information according to the input information, wherein the target information comprises a response information for the input information.
